(19) United States
(12) Patent Application Publication
(10) Pub. No.: US 2019/0247149 A1
(43) Pub. Date: Aug. 15, 2019

(54) CUSTOM DENTAL COMPONENT AND SCAN BODY

(71) Applicant: EVOLLUTION IP HOLDINGS, INC., Birmingham, AL (US)

(72) Inventor: Boris A. SIMMONDS, Vestavia, AL (US)

(73) Assignee: EVOLLUTION IP HOLDINGS, INC., Birmingham, AL (US)

(21) Appl. No.: 16/274,585

(22) Filed: Feb. 13, 2019

Related U.S. Application Data
(60) Provisional application No. 62/629,831, filed on Feb. 13, 2018.

(51) Int. Cl. A61C 8/00; A61C 13/00; A61C 13/34; A61C 9/00

(52) U.S. Cl. CPC A61C 8/0001; A61C 13/0004; B33Y 80/00; A61C 9/0053; A61C 13/0019; A61C 13/34

(57) ABSTRACT

A custom dental component and scan body for supporting the soft tissue surrounding an implant that is installed in at least a portion of a patient's jaw bone during the dental restoration process. The custom dental component includes a custom subgingival emergence profile so as to support and train the surrounding soft tissue. The custom dental component, while remaining connected with the implant, is scanned or an impression is obtained. A three-dimensional digital model of the patient's detention is produced from the scan or impression. A dental design software is used to view the three-dimensional digital model. A digitally-designed custom dental component is imported in the three-dimensional digital model and aligned with the custom dental component to obtain the implant's position.

### CROSS-REFERENCE TO RELATED APPLICATION

This application claims the benefit of U.S. Provisional Patent Application Ser. No. 62/629,831 filed Feb. 13, 2018, the entirety of which is hereby incorporated herein by reference for all purposes.

### TECHNICAL FIELD

The present invention relates generally to the field of restorative implant dentistry, and more particularly to apparatus, systems and methods of production and use of custom dental components and realizing implant position throughout the process while maintaining support for surrounding gingiva.

### BACKGROUND

Dental implants are commonly used in restorative dentistry to affix a dental prosthesis to the jaw of a human or animal patient. Typically, a dental practitioner installs an externally threaded implant into an aperture formed in the bone of the patient's jaw, to which an artificial tooth, crown, or other dental prosthesis will be attached. After placement of the implant, the surrounding bone tissue is allowed to heal and an abutment mount upon which the dental prosthesis is fabricated is secured to the implant. Typically, an abutment screw is used to attach the prosthesis to the implant via an anchoring bore through the abutment and into an internally threaded bore in the implant. Optionally, a temporary crown or healing abutment may be attached to the implant during healing and fabrication of a permanent prosthesis.

A physical model of the patient's intraoral cavity may be utilized to facilitate design and manufacture of the dental prosthesis to be mounted to the implant. Traditionally, the model was produced by impression molding using a dental impression tray and impression material to cast a replica of the patient's intraoral structure (an “analog” process of producing a model). More recently, models have been made using an electronic intraoral scanner to generate a digital model, from which a physical model can be created by 3D printing, CNC milling, or other computer aided manufacture technique (a “digital” process of producing a model). The models or casts are typically formed from dental plaster or gypsum stone, acrylic, or polymeric resins, and may be of a full or partial dental arch of one or both of the patient's upper and lower jaw dentition.

The location and orientation of a dental implant that has been placed in the patient's jaw is transferred to the physical dental model by use of an impression coping engaged in the implant (using an analog modeling process), or by a scan body engaged in the implant (using a digital modeling process). In either case, the healing abutment, temporary crown or other abutment must be removed from the implant so that the impression coping or scan body can be attached. Traditionally, removal of the healing abutment, crown or other abutment causes pain and discomfort to the patient and further irritates and removes support for the gingiva surrounding the implant. Further, common impression copings and scan bodies are typically symmetrical in shape and lack any profile for supporting the surrounding gingiva, thereby negatively impacting the healing and support of the surrounding gingiva when placed in the implant to take an impression or obtain a scan.

Accordingly, it can be seen that needs exist for improved apparatus, systems and methods of production and use of custom dental components and realizing implant position throughout the process of restorative implant dentistry while maintaining support for surrounding gingiva. It is to the provision of improved apparatus, systems and methods meeting these and other needs that the present invention is primarily directed.

### SUMMARY

In example embodiments, the present invention provides a custom dental component and scan body for supporting the soft tissue surrounding an implant that is installed in at least a portion of a patient's jaw bone during the dental restoration process. In example forms, the custom dental component includes a custom subgingival emergence profile so as to support and train the surrounding soft tissue. The custom dental component, while remaining connected with the implant, is scanned or an impression is obtained. A three-dimensional digital model of the patient's detention is produced from the scan or impression. A dental design software is used to view the three-dimensional digital model. A digitally-designed custom dental component is imported in the three-dimensional digital model and aligned with the custom dental component to obtain the implant's position.

In one aspect, the present invention relates to a custom dental component for secure attachment with an implant or implant analog. The custom dental component includes a custom subgingival emergence profile so as to support the gingiva surrounding the implant. The custom dental component is a digital impression coping such that it is recognizable by a scanner to produce at least a portion of a digital three-dimensional dental model showing the custom dental component and surrounding gingiva and detention. In example embodiments, the custom dental component need not be temporarily replaced with an impression coping or scan body to realize the position of the implant or implant analog.

In example embodiments, once the custom dental component is securely attached to the implant, the custom dental component remains securely attached with the implant until placement of a final restoration, wherein an impression coping or digital scan body need not be attached to the implant to determine the implant's position and surrounding gingiva and detention. In example embodiments, the emergence profile of the custom dental component is configured to train the surrounding gingiva and produce a desirable gingival profile for compatibility with an emergence profile of the final restoration.

In example embodiments, a design and planning software is provided for accessing the digital three-dimensional dental model, wherein a digitally-designed custom dental component that is substantially similar to the custom dental component is aligned with the custom dental component that is visible in the digital three-dimensional dental model, the alignment of the digitally-designed custom dental component with the custom dental component of the digital three-dimensional dental model being configured for producing the implant's position and orientation within a patient's jaw bone.

In example embodiments, one or more digitally-designed stock or custom dental components can be aligned with the digitally-designed custom dental component so as to be properly positioned relative to the implant or implant analog. In example embodiments, the custom dental component is a custom healing abutment. In example embodiments, the custom dental component is a stock or custom abutment. In example embodiments, the custom dental component is a stock or custom coping. In example embodiments, the custom dental component is a stock or custom full contour tooth. In example embodiments, the custom dental component is a stock or custom bridge and/or bridged framework. In example embodiments, the custom dental component is monolithic and formed from a single unitary material. In example embodiments, the custom dental component has a hybrid construction having at least two components that are connected together by frictional engagement or an adhesive. In example embodiments, the two components of the custom dental component are configured for frictionally snapping together.

In example embodiments, the custom dental component has a connection that is configured for engagement with a connection receiver of the implant or implant analog. In example embodiments, the connection is configured frictionally engaging the connection receiver so as to retain the custom dental component with the implant or implant analog without a screw, the frictional engagement being sufficient so as to prevent unintentional removal of the connection from the connection receiver. In example embodiments, the connection is configured frictionally engaging the connection receiver so as to retain the custom dental component with the implant or implant analog, and wherein a screw is provided to further secure the custom dental component to the implant or implant analog.

In another aspect, the present invention relates to a method of realizing the position of an implant of a patient including obtaining a scan of at least a portion of a patient's jaw bone, wherein at least one implant is installed in at least a portion of the patient's jaw bone; digitally designing a custom dental component for attachment to an implant that is to be installed in the patient's jaw bone; manufacturing the digitally-designed custom dental component to produce a physical custom dental component; installing the physical custom dental component in the implant of the patient; obtaining a scan of the patient, the scan providing visibility of the physical custom dental component; aligning the digitally-designed custom dental component with the physical custom dental component that is visible in the scan of the patient; and realizing the position of the implant of the patient. In example embodiments, one or more additional digital dental components can be aligned relative to the digitally-designed custom dental component that is aligned with the physical custom dental component and visible in the scan of the patient, the one or more additional digital dental components being positioned and oriented based on the position of the implant or implant analog, the one or more additional digital dental components being customizable so as to train the surrounding tissue to provide a desired emergence profile.

In example embodiments, the custom dental component is a custom healing abutment. In example embodiments, the custom dental component is a custom temporary abutment and a temporary restoration is attached with the custom temporary abutment. In example embodiments, the custom dental component is a custom final abutment and a final restoration is attached with the custom final abutment. In example embodiments, the custom dental component is a crown or full contour tooth. In example embodiments, the custom dental component is a bridge or bridged framework. In example embodiments, at least two implants are installed within the patient's jaw bone, and wherein aligning the digitally-designed custom dental component with the custom dental component of the digital three-dimensional dental model identifies the position of the at least two implants. In example embodiments, the custom dental component is monolithic and formed from a single unitary material. In example embodiments, the custom dental component has a hybrid construction having at least two components that are connected together.

In yet another aspect, the present invention relates to a method of realizing the position of an implant of a patient including digitally designing a custom dental component for attachment to the implant, the digitally-designed custom dental component being sized and shaped according to nondigital measurements; manufacturing the digitally-designed custom dental component to produce a physical custom dental component; installing the physical custom dental component in the implant of the patient; obtaining a scan of the patient to produce at least a portion of a digital three-dimensional dental model showing the custom dental component and surrounding gingiva and detention; aligning the digitally-designed custom dental component with the custom dental component of the digital three-dimensional dental model; and realizing the position of the implant of the patient, wherein one or more stock or custom digitally-designed dental components can be aligned relative to the digitally-designed custom dental component that is aligned with the custom dental component of the digital three-dimensional dental model.

In example embodiments, the one or more stock or custom digitally-designed dental components are selected from the group consisting of an implant, an implant analog, a stock or custom healing abutment, a stock or custom temporary abutment or final abutment, a stock or custom temporary restoration or final restoration, and a stock or custom bridge or bridged framework.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a full contour crown according to an example embodiment of the present invention.

FIG. 2 is a perspective view of a digital three-dimensional dental model comprising the full contour crown of FIG. 1, and further comprising a digitally-designed full contour crown to be aligned with the full contour crown of the digital three-dimensional dental model.

FIG. 3 shows a perspective view of the digital three-dimensional dental model with the digitally-designed full contour crown aligned with the full contour crown of the digital three-dimensional dental model.

FIG. 4 shows a perspective view of the digital three-dimensional dental model, showing an implant analog and a monolithic custom abutment positioned therewith according to another example embodiment of the present invention.

FIG. 5 shows a perspective view of a hybrid abutment connected by means of a titanium base abutment to the implant analog according to another example embodiment of the present invention.

FIG. 6 shows a perspective view of a digital three-dimensional dental model comprising the abutment of FIG. 5, and further comprising a digitally-designed abutment to be aligned with the hybrid abutment of the digital three-dimensional dental model.

FIG. 7 shows a perspective view of the digital three-dimensional dental model of FIG. 6 with the digitally-designed abutment aligned with the abutment of the digital three-dimensional dental model.

FIG. 8 shows a side perspective view of the digital three-dimensional dental model of FIG. 7, showing a second abutment overlaying the abutment.

FIG. 9 shows a perspective view of a digital three-dimensional dental model comprising a custom healing abutment according to another example embodiment of the present invention.

FIG. 10 shows a perspective view of the custom healing abutment of FIG. 9.

FIG. 11 shows a perspective view of a custom healing abutment according to another example embodiment of the present invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Example embodiments of the present invention relate to custom dental components and to methods of realizing the position of at least one implant installed in a jaw bone of a patient (or an implant analog installed in a physical model of the patient's impression) without requiring attachment of an impression coping or digital scan body to the implant or implant analog. In example embodiments, the custom dental components of the present invention can function as scan bodies so that they can be scanned and recognized during a modeling process of at least a portion of the patient's detention. In example embodiments, the dental model that is created from the modeling process comprises a three-dimensional digital model of the patient's detention including the one or more custom dental components connected with the one or more dental implants and the surrounding teeth and soft tissue, mucosa or gingiva. According to example embodiments, a dental practitioner uses an intraoral optical or computed tomography (CT) scanner to create the three-dimensional digital model of the patient's dentition. Thus, the patient's detention is digitally reproduced directly from the scanner, for example, such that a three-dimensional digital model is viewable by a dental design software (such as for example the 3Shape Dental System of 3Shape A/S of Copenhagen Denmark).

In alternate embodiments, the dental model of the patient's detention, custom dental component installed in the implant, and surrounding teeth and gum tissue may be produced using an analog modeling process, for example using impression material within an impression tray, pressed over the patient's dentition, and cured and removed to form a mold. The impression mold may then be used to cast the physical model from dental modeling plaster, gypsum stone or resin. Once the physical model is produced, the physical model can then be scanned (via an intraoral or desktop scanner) to produce a three-dimensional digital model of the physical model. Thus, according to example embodiments of the present invention, the three-dimensional digital model of the patient can be obtained by a digital or analog modeling process.

Once the three-dimensional digital model is opened and viewable in the dental design software, a digitally-designed custom dental component (e.g., substantially identical to the custom dental component connected with the implant) can be imported or built to correspond to the custom dental component of the three-dimensional digital model. The digitally-designed custom dental component is then aligned to match the position and orientation of the custom dental component of the three-dimensional digital model. Accordingly, by aligning and matching the position and orientation of the digitally-designed custom dental component with the custom dental component of the three-dimensional digital model, the location, configuration, and orientation of the implant placed in the patient's jaw is realized.

Thereafter, a dental practitioner, laboratory, or other dental restoration professional can begin designing and preparing for manufacture and installation of another custom dental component. For example, according to some example embodiments, the custom dental component can be a healing cap or a healing abutment, a temporary or final abutment, a temporary or final restoration, a full contour tooth, a coping component, or a bridge (or bridged framework). Thus, depending on where the patient is in the dental implant restoration process, the next custom dental component to be designed after realizing the implant's position can vary and depend on several factors. Typically, the patient's health, age, onset of osteoporosis, detention, jaw bone structure, and location(s) of the one or more implants plays a role in determining the planning of the dental implant restoration process, and for example, plays a role in which of the various custom dental components are to be designed and manufactured for attachment to the one or more implants.

According to one example embodiment, the custom dental components and methods as described herein can be implemented during the planning and preparation of guided surgery. Thus, a three-dimensional digital model of the patient's detention may be produced prior to installation of the one or more implants such that the custom dental components can be designed and manufactured prior to surgery for connection to the one or more implants directly after installation of the one or more implants. Thereafter, the custom dental components, without being removed from the one or more implants, can be scanned and a three-dimensional digital model of the patient's detention and custom dental components (connected with the one or more implants) is created for use with the dental design software. The one or more digitally-designed custom dental components can be imported or built to correspond to the custom dental components of the three-dimensional digital model. The digitally-designed custom dental components are then aligned to match the location, position and orientation of the custom dental components of the three-dimensional digital model to obtain data corresponding to the location, position and orientation of the one or more implants installed in the patient's jaw bone.

According to another example embodiment, the custom dental components and methods as described herein can be implemented at any point throughout the dental implant restoration process, for example, rather than beginning with the planning and design of guided surgery prior to installation of the one or more implants. For example, one or more implants may already be installed in the patient's jaw bone prior to the design and manufacture of the custom dental components. According to one example embodiment, a custom dental component is independently digitally designed based on nondigital measurements while still providing a supportive emergence profile for supporting and training the soft tissue or gingiva surrounding the one or more implants. According to another example embodiment, the custom dental component is organically-shaped and sized to be specific to the patient, and for example, to assist in both the healing of the gingiva surrounding the one or more implants and the development of a custom emergence profile by the gingiva and defined by a custom subgingival emergence profile of the custom dental component. In example embodiments, the custom subgingival emergence profile not only supports and trains the gingiva surrounding the implant, the custom subgingival emergence profile benefits the healing process of the gingiva. Further, as the custom dental component is also a scan body (e.g., digital impression coping), the custom dental component need not be removed from the implant in order to obtain a physical or digital three-dimensional model, and thus, the surrounding gingiva remains supported by the custom subgingival emergence profile up until the custom dental component is to be removed for replacement with a new, revised or different custom dental component.

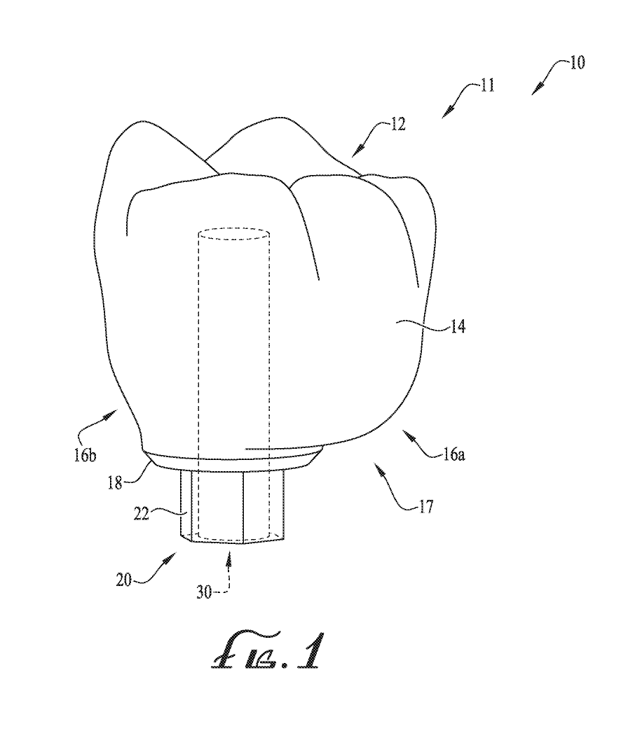

With reference now to the drawing figures, wherein like reference numbers represent corresponding parts throughout the several views, FIG. 1 shows a custom full contour crown 10 for attachment to an implant that is installed in a jaw bone of a patient or an implant analog installed in a physical model of at least a portion of the patient's detention and surrounding gingiva. In example embodiments, the crown 10 comprises a body 11 comprising a tooth shaped top surface 12 (e.g., defining occlusal features), side surfaces 14, and lower surfaces 16a, 16b defining a custom subgingival emergence profile 17 extending from an implant contact portion 18 of the crown 10 to the side surfaces 14. In example embodiments, the custom subgingival emergence profile 17 can preferably be shaped and sized so as to support and train the gingiva surrounding the implant. In example embodiments, the custom subgingival emergence profile not only supports and trains the gingiva surrounding the implant, the custom subgingival emergence profile benefits the healing process of the gingiva. Further, as the crown 10 is also a scan body, the crown 10 need not be removed from the implant in order to obtain a physical or digital three-dimensional model (e.g., to determine the implant position), and thus, the surrounding gingiva remains supported by the custom subgingival emergence profile 17 up until the crown 10 is removed for attachment of a final abutment and final restoration, or for example, for attachment of any other desired custom dental component.

According to example embodiments, different tools, such as control points and lines can be provided for digitally designing the custom dental component (e.g., the crown 10). According to example embodiments, the tools allow the custom dental component to be shaped and sized as desired, for example, to be taller, shorter, wider, narrower, thicker, and/or its shape can be morphed to provide an organically shaped and aesthetically pleasing component. According to example embodiments, the dental design software can be utilized to customize the custom dental component (e.g., the crown 10 is this particular embodiment). Optionally, a computer aided design software (CAD) or other 3D modeling software can be utilized for designing and customizing the custom dental component as desired.

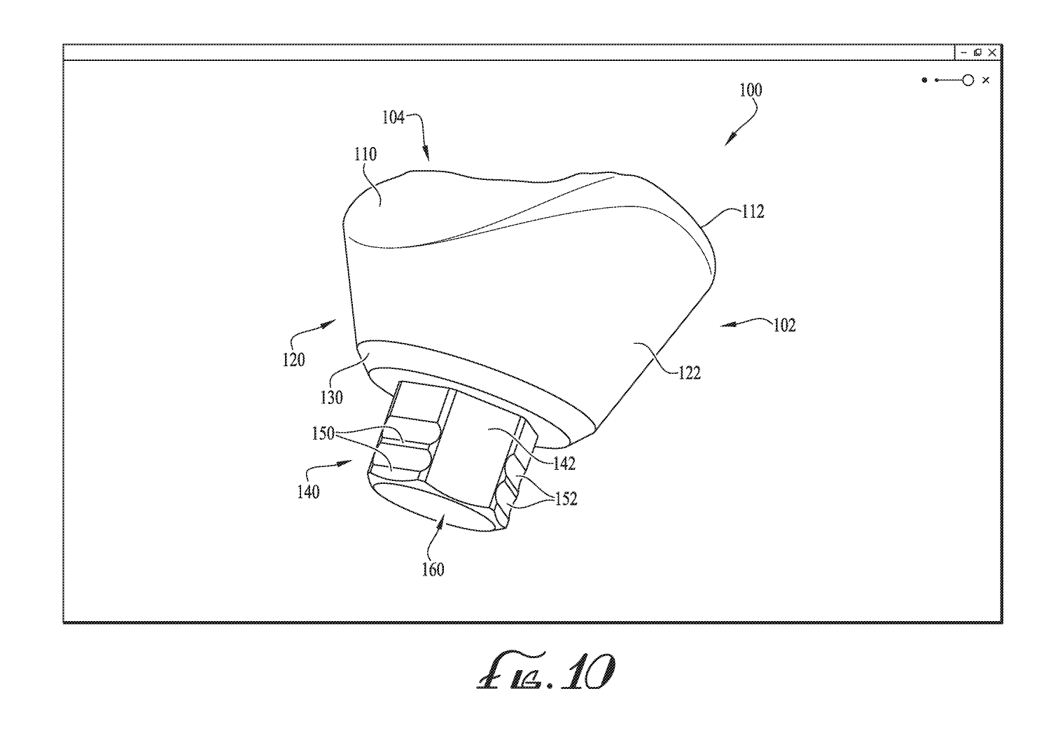

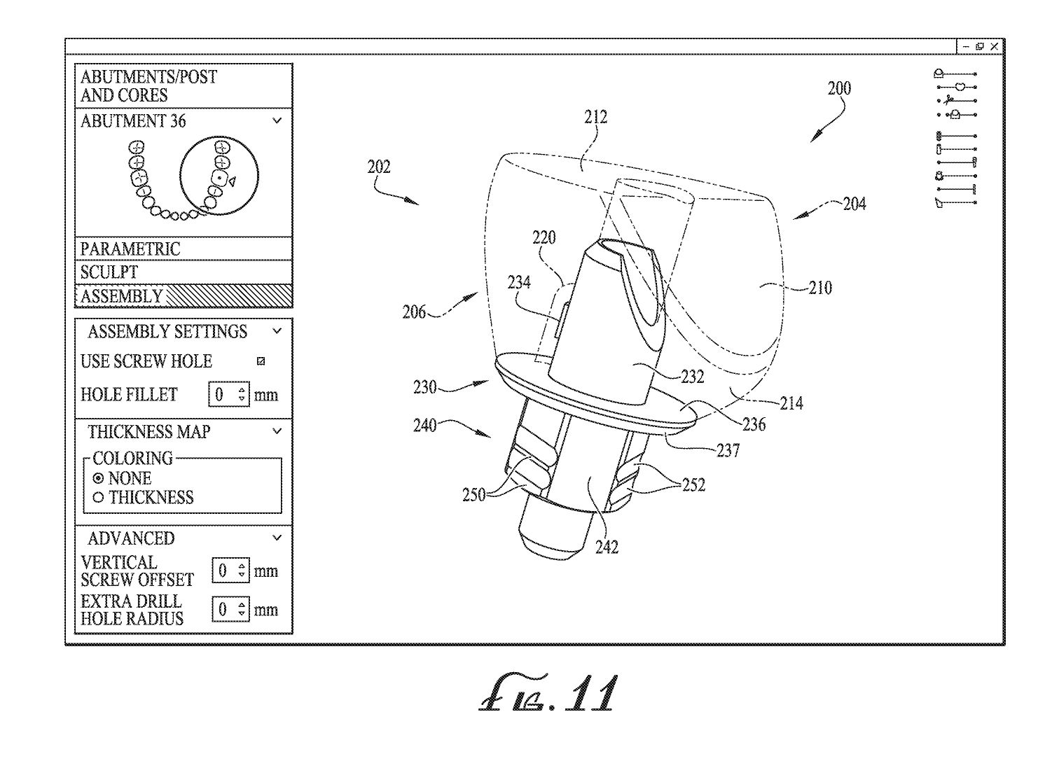

Referring to FIG. 1, the crown 10 comprises a hexagonal connection portion 20 configured for closely fitting installation within a hexagonal recess of the implant (or implant analog). In example embodiments, the connection portion 20 defines one or more surfaces 22, for example, about six surfaces to define the hexagonal shaped connection portion. A bore or conduit 30 can be formed through the entirety of the crown 10 so as to allow a fastener or abutment screw to extend therethrough for securing the crown 10 to the implant. According to example embodiments, the conduit 30 extends entirely through the crown 10 from the tooth shaped top surface 12 to the connection portion 20. Optionally, as will be described in greater detail below, the connection portion 20 can be configured for frictionally engaging the hexagonal recess of the implant or implant analog, for example, such that a fastener or screw is not required to maintain secure engagement of the connection portion 20 with the implant or implant analog (see FIGS. 10-11). According to one example embodiment, the frictional engagement therebetween is substantially sufficient so as to prevent unintentional or accidental removal of the crown 10 from the implant or implant analog. Optionally, the connection of the crown 10 with the implant or implant analog can be a combination of frictional engagement and the screw. As described above, the crown 10 also comprises the implant contact portion 18 (or lower abutment surface) for butt-joint contact with the top face of the dental implant when placed in the patient's mouth (or correspondingly with the annular abutment contact surface of the implant analog).

According to example embodiments, the crown 10 is preferably custom to the patient so as to be shaped organically and provide the custom subgingival emergence profile 17 for supporting and training the gingiva to a desired emergence profile. For example, according to example embodiments, the custom subgingival emergence profile 17 is preferably designed so as to train the surrounding gingiva to be shaped according to the desired custom emergence profile of the final prosthesis or restoration. Thus, at the time of replacing the crown 10 with a final restoration (or final abutment and restoration), the emergence profile of the surrounding gingiva is healthy and already at least partially shaped according to the custom emergence profile of the final restoration. According to another example embodiment, the custom emergence profile can be customized based on the present gingival condition, for example, rather than designing the custom emergence profile based upon the desired custom emergence profile of the final restoration.

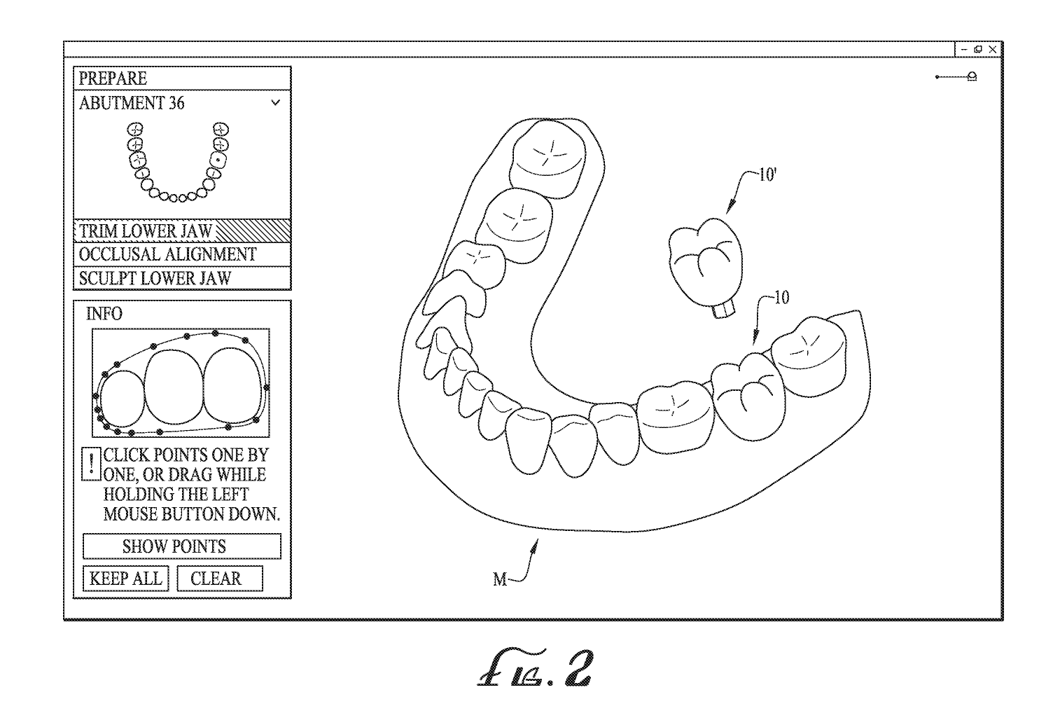

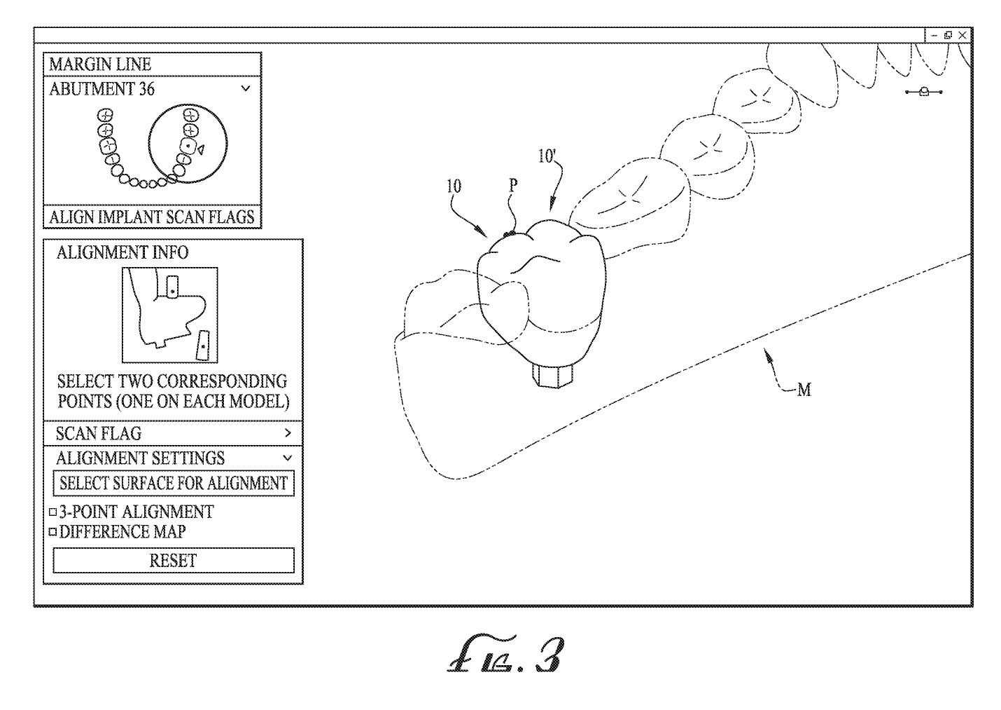

FIGS. 2-3 depict a three-dimensional digital model M of the patient that was scanned in the dental design software after installation of the crown 10. As depicted in FIG. 2, the digital model M is shown and comprises the crown 10, one or more surrounding teeth and gingiva. A digitally-designed crown 10′ that is substantially identical to the crown 10 (e.g., which is used to manufacture the physical crown 10), is imported in the three-dimensional digital model M. The digitally-designed crown 10′ is then manipulated to become substantially aligned (if not entirely aligned) with the crown 10 (see FIG. 3).

According to example embodiments of the present invention, one or more common points P can be selected on respective crowns 10, 10′ and an alignment process can begin such that the location, position and orientation of the implant or implant analog can be realized. According to some example embodiments, the respective crowns 10, 10′ (and digital model M) are comprised point clouds of data relating to the surfaces thereof. Accordingly, during the alignment process, the point clouds of data defining the crowns 10, 10′ are processed, for example, by use of an algorithm or other processing medium, for example, such that one or more mathematical calculations are made so as to align and arrange the crown 10′ with the crown 10. As depicted in FIG. 3, a single point alignment process is used whereby a common point P on each of the crowns 10, 10′ is selected to provide alignment of the digitally-designed crown 10′ with the crown 10.

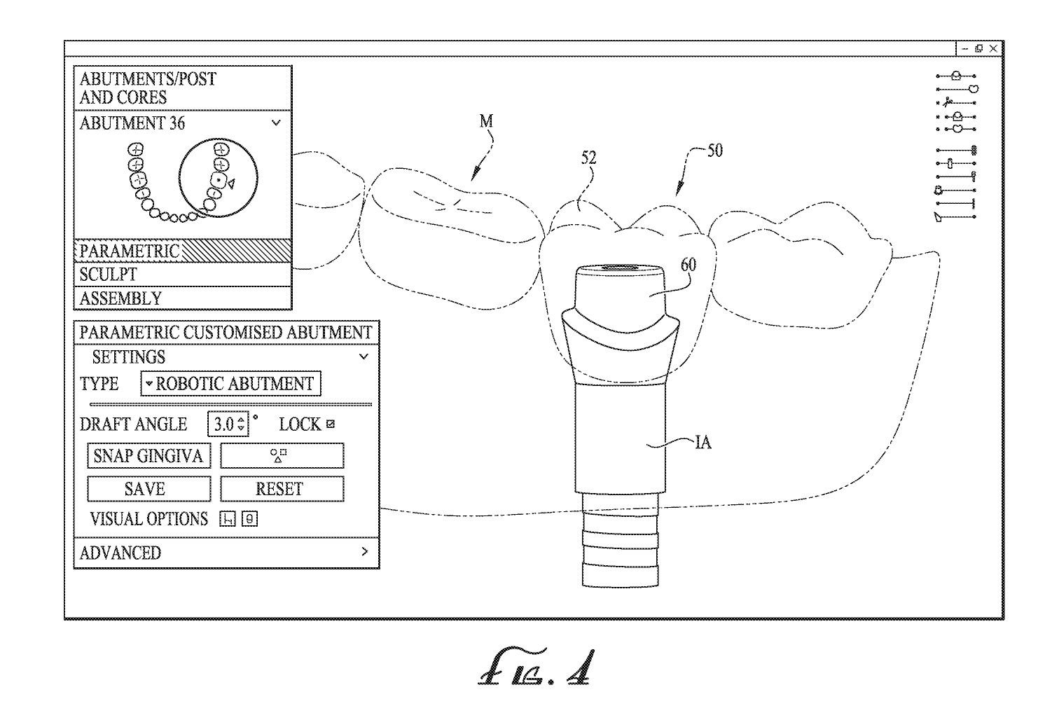

After alignment of the digitally-designed crown 10′ with the crown 10, the location, position and orientation of the implant is realized, and thus, additional custom dental components, for example, a digital restoration 50 (e.g., comprising a crown 52 attached to a hybrid abutment 60) can be custom designed based upon the patient's three-dimensional digital model M including the teeth neighboring implant, the gingiva surrounding the implant and/or other various factors (see FIG. 4). According to one example embodiment, one or more digitally-designed custom dental components can be saved to a library that is accessible by the dental design software so that the one or more digitally-designed custom dental components can be imported in the three-dimensional digital model M, for example, to allow for the placement thereof relative to the realized implant position. The one or more digitally-designed dental components can then be further customized based upon the three-dimensional digital model, the realized implant position, neighboring teeth, and the condition and profile of the gingiva.

According to another example embodiment, one or more traditionally stock dental components can be imported and positioned according to the realized implant position. Thereafter, the traditionally stock dental components can be customized so as to provide a patient-specific custom dental component based upon the three-dimensional digital model, the realized implant position, neighboring teeth, and the condition and profile of the gingiva.

According to one example embodiment, the crown 10 as described above is preferably formed from a single and unitary material, for example, titanium, cobalt chrome (CoCr), other metals or metal alloys, ceramic, polyether ether ketone (PEEK), poly(methyl methacrylate) (PMMA), or other known or available materials as desired. Thus, the body 11 and connection portion 20 can comprise a monolithic construction so as to be formed from a single piece of material. For example, according to one example embodiment, a physical stock symmetrical cylindrical abutment comprising a hexagonal connection portion and a bore extending therethrough can be machined so as to form the crown 10′ or other desired custom dental component. According to another example embodiment, a physical solid cylinder can be machined to comprise the crown base (and portions thereof), the connection portion and the bore extending therethrough, or for example, other desired custom dental components can be machined from the physical solid cylinder as desired.

In alternate example embodiments, the crown 10 can comprise a hybrid construction so as to be formed from two or more connectable pieces. For example, according to one example embodiment, the crown 10 can optionally be constructed to comprise a hybrid abutment 60 and a crown 52 for placement atop the hybrid abutment 60. For example, FIG. 4 depicts the digital restoration 50 aligned and positioned with the crown 10′ (and realized implant position thereof), wherein the crown 10′ is hidden from view so as to visualize the fit of the digital restoration 50 relative to the realized implant position and neighboring teeth and gingiva captured in the three-dimensional digital model M.

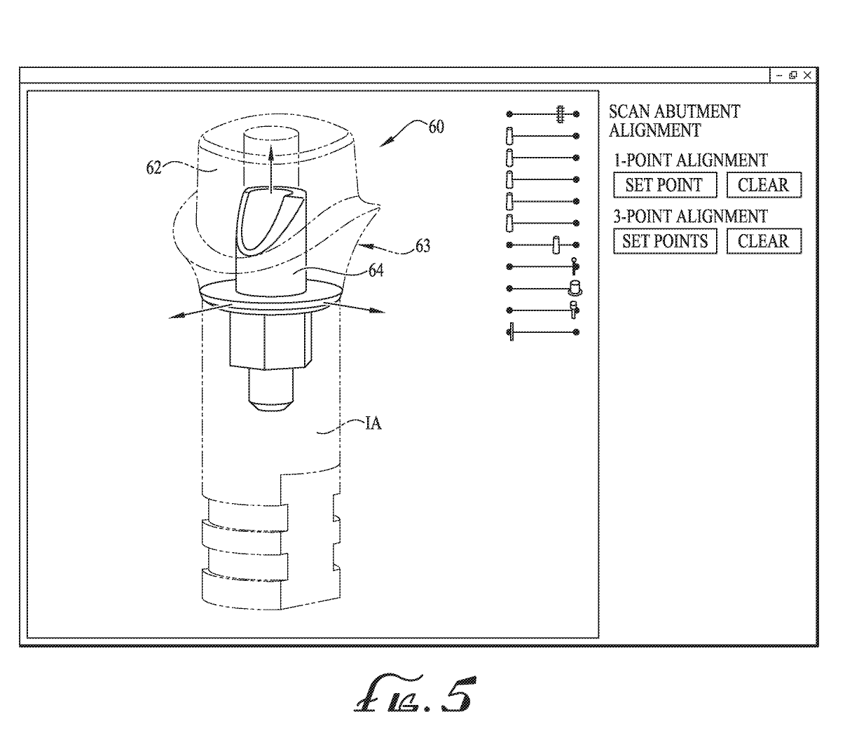

In example embodiments, the hybrid abutment 60 comprises a custom upper abutment portion 62 and a base implant-connecting portion 64 (see FIG. 5). As shown, the abutment portion 62 comprises an bore or opening extending therethrough for receiving at least a portion of an upper connecting post of the base portion 64, and which allows for extension of a screw or fastener therethrough for securing the hybrid abutment 60 to the implant or implant analog. In example embodiments, a lower portion of the abutment portion 62 comprises lower surfaces defining a custom subgingival emergence profile 63 that can preferably be patient-specific and shaped and sized so as to support and train the gingiva surrounding the implant. In example embodiments, the custom emergence profile 63 can comprise one or more concave surfaces so as to adequately support and train the gingiva surrounding the implant.

According to example embodiments, the base implant-connecting portion 64 is generally prefabricated and generally stock such that it can support any number of custom abutment portions. According to one example embodiment, the base implant-connecting portion 64 can be customized and designed according to the patient's detention and custom abutment portion to be connected therewith. According to some example embodiments, the upper connecting post comprises an outwardly-extending protrusion that is configured for fitting engagement with a recess of the abutment portion 62, for example, to maintain a certain orientation of the abutment portion 62 with the base portion 64 (see also FIG. 11). Optionally, other complementary alignment features can be provided with the abutment and base portions 62, 64 such that rotation of one of the portions 62, 64 relative to the other of the portions 62, 64 is prevented. In example embodiments, the abutment portion 62 and base portion 64 are bonded together with adhesive, glue, cement or by other attachment means. For example, according to one example embodiment, the abutment portion 62 can be configured for frictional snap-in engagement with the base portion 64 rather than adhering the two together. According to one example embodiment, one or more surface and/or engagement features can be provided with the abutment portion 62 and base portion 64 so as to facilitate the frictional snap-in engagement therebetween.

According to another example embodiment, the hybrid abutment 60 can be formed to comprise a monolithic construction, for example, wherein the upper abutment portion 62 and the implant-connecting base portion 64 are formed from a single unitary piece of material. For example, according to example embodiments, the monolithic abutment is formed from a ceramic, polymer or other desired material and is milled or machined so as to form a one-piece abutment comprising an upper abutment portion integrally formed with a lower connection portion.

After the digitally-designed custom dental component is aligned relative to the custom dental component of the three-dimensional digital model, one or more additional digital dental components (custom or stock) can be aligned and positioned against the digitally-designed custom dental component, and thus are aligned with the realized position of the implant or implant analog. For example, according to example embodiments, a connection portion of one or more additional digital dental components can be aligned or mated to the connection portion of the digitally-designed custom dental component 10′. As such, the one or more additional digital dental components need not have a substantially similar shape, profile, size, function, etc.

According to one example embodiment, the additional digital dental component comprises the digital restoration 50, which is preferably accessible from the dental design software and imported therein to be aligned with the digitally-designed custom dental component 10′, thereby positioning the digital restoration 50 according to the realized position of the implant or implant analog. Thereafter, the digital abutment portion 62 and digital crown 52 of the digital restoration 50 can be customized in the dental design software as desired and saved to the library or database accessible by the dental design software. After completing designing and customizing the digital abutment portion 62 and digital crown 52, the digital files associated with therewith (and that are saved to the dental design software library) are output to be fabricated or manufactured by CNC milling or other computer aided manufacturing (CAM) digital fabrication processes.

After being manufactured, the physical fabricated custom abutment portion 62 is secured with the base portion 64 to form the hybrid abutment 60. The physical custom hybrid abutment 60 can then be placed in the implant of the patient and secured thereto with an abutment screw or other fastener. The custom crown 52 can then be placed on the custom hybrid abutment 60 and secured therewith with glue or other adhesives. Optionally, rather than retaining the custom hybrid abutment 60 in the implant with a screw and retaining the custom crown 52 on the custom hybrid abutment 60 with an adhesive, the custom hybrid abutment 60 can optionally be configured for a frictional snap-in engagement with the implant and the custom crown 52 can be configured for a frictional snap-in engagement with the custom hybrid abutment 60. In example embodiments, the frictional snap-in engagement is preferably substantially sufficient to withstand accidental or unintentional disengagement. Thus, according to some example embodiments, the restoration 50 can be assembled together without any adhesive or glue whatsoever, for example, such that the assembly thereof relies entirely on a frictional snap-in engagement. In other example embodiments, the custom abutment portion 62, the custom crown 52, base portion 64 and the implant can be configured for secure attachment by a combination of fasteners, adhesives and various forms of frictional snap-in engagement.

According to example embodiments, the restoration 50 can be in the form of a final restoration (e.g., the custom abutment 60 is a custom final abutment and the custom crown 52 is a custom final restoration). According to another example embodiment, the restoration 50 can be in the form of a temporary restoration (e.g., the custom abutment 60 is a custom final abutment and the custom crown 52 is a custom final restoration). Preferably, in either case, the restoration comprises a custom emergence profile for supporting and training the gingiva.

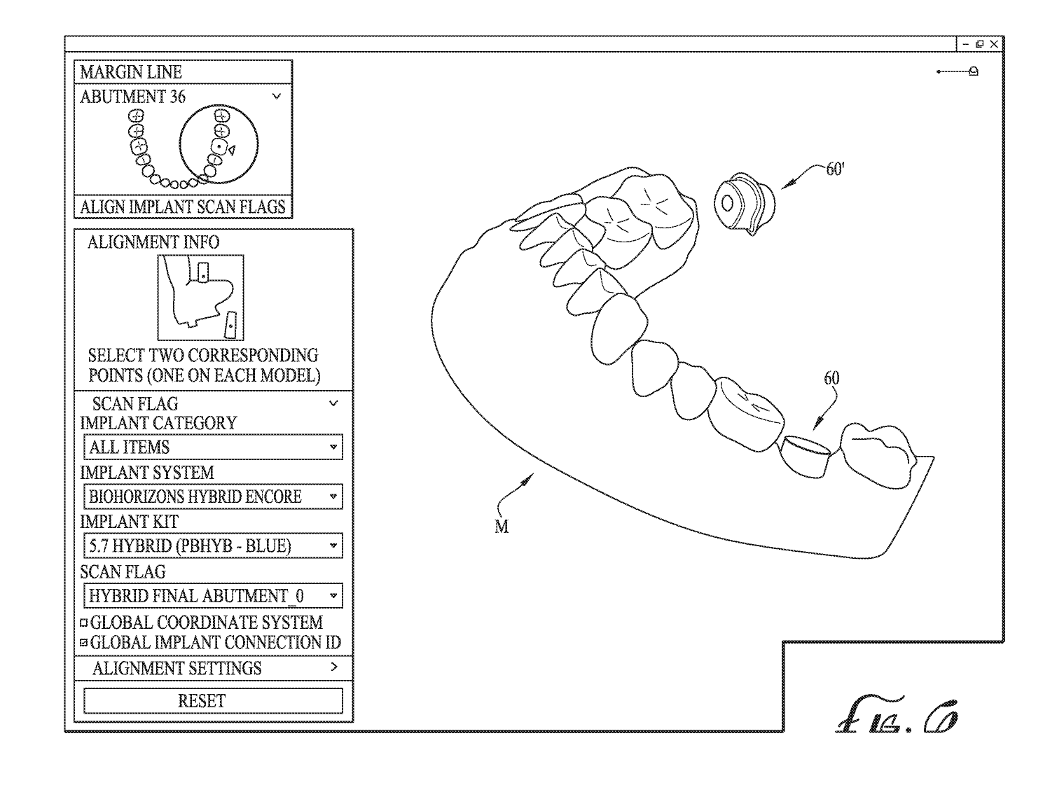

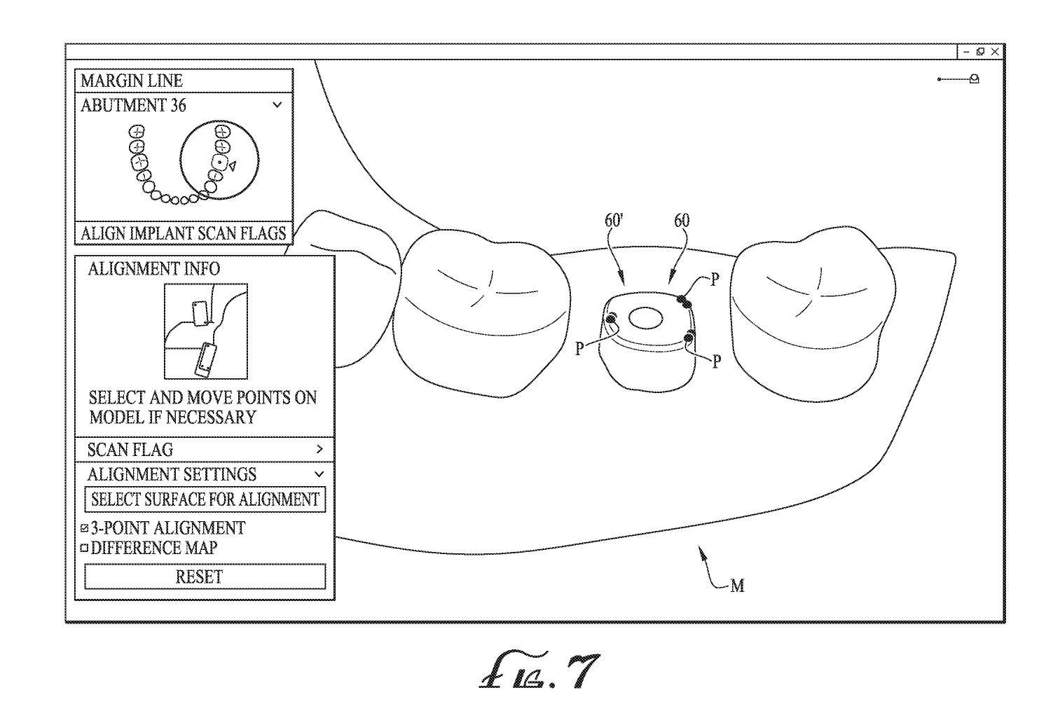

FIGS. 6-7 show three-dimensional digital model M of the patient that was scanned in the dental design software wherein a custom abutment 60 is installed with the implant that is installed within the patient's jaw bone. As depicted, the digital model M is shown and comprises the custom abutment 60, one or more neighboring teeth and gingiva. As similarly described above, a digitally-designed custom abutment 60′ that is substantially identical to the custom abutment 60 (e.g., which is used to manufacture the physical abutment 60), is imported in the three-dimensional digital model M. The digitally-designed custom abutment 60′ is then manipulated to become substantially aligned (if not entirely aligned) with the custom abutment (see FIG. 7).

As similarly described above, one or more common points P can be selected on respective abutments 60, 60′ and an alignment process can begin such that the location, position and orientation of the implant or implant analog can be realized. According to some example embodiments, the respective abutments 60, 60′ are comprised point clouds of data relating to the surfaces thereof. Accordingly, during the alignment process, the point clouds of data defining the abutments 60, 60′ are processed, for example, by use of an algorithm or other processing medium, for example, such that one or more mathematical calculations are made so as to align and arrange the abutment 60′ with the abutment 60. As depicted in FIG. 7, a 3-point alignment process is used whereby three common points P on each of the abutments 60, 60′ are selected to provide alignment of the digitally-designed abutment 60′ with the abutment 60. In alternate example embodiments, the 1-point alignment process can be utilized, or for example, four or more common points can be chosen from respective abutments 60, 60′ to align the digitally-designed abutment 60′ with the abutment 60 and determine the location, position and orientation of the implant or implant analog.

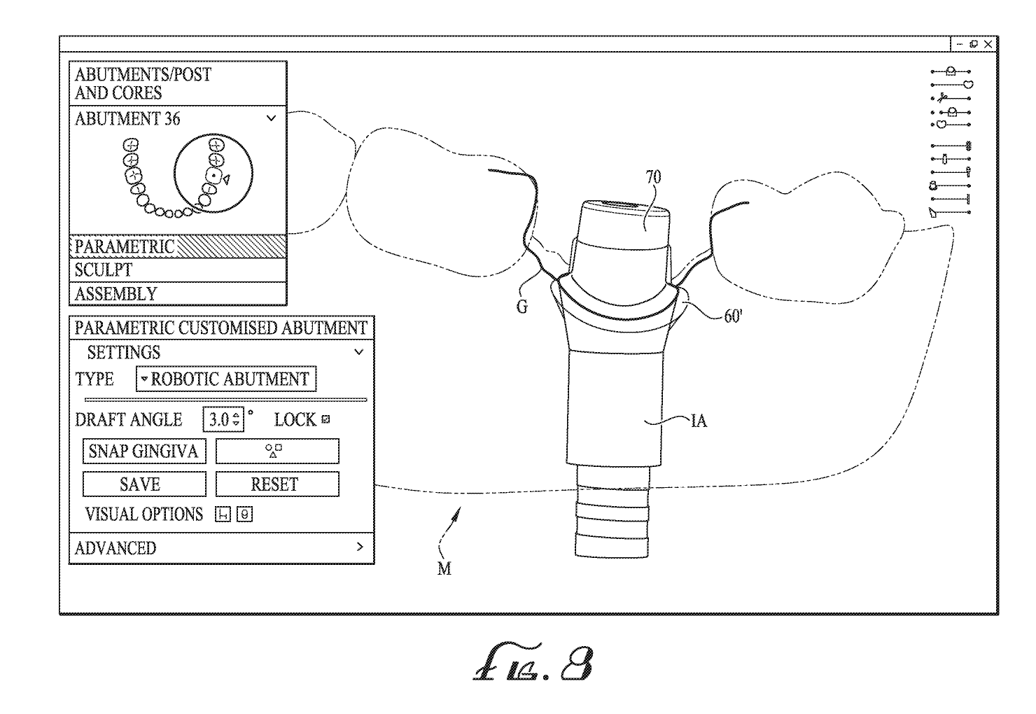

As similarly described above, once the implant position is realized (e.g., by the 3-point alignment of the digitally-designed abutment 60′ with the abutment 60 of the digital model M), one or more additional dental components (custom or stock) can be imported from the library of the dental design software, for example, to be aligned with the realized position of the implant or implant analog. For example, as depicted in FIG. 8, a digitally-designed final abutment 70 is aligned with the realized implant or implant analog position of the digital model M to begin planning, design and fabrication of the final restoration (e.g., final abutment 70 and final prosthesis). In example embodiments, a transparent overlay of the scanned-in abutment 60 of the digital model M is shown for comparison against the final abutment 70. Furthermore, preexisting gingival margins and subgingival contours G can be visualized within the dental design software, for example, so as to benefit in the customization of the final abutment 70, and for example, to provide the final abutment 70 with an adequate emergence profile for supporting the gingiva. Furthermore, a final prosthesis can be imported in the dental design software and aligned with the final abutment 70, for example, to begin customizing the same.

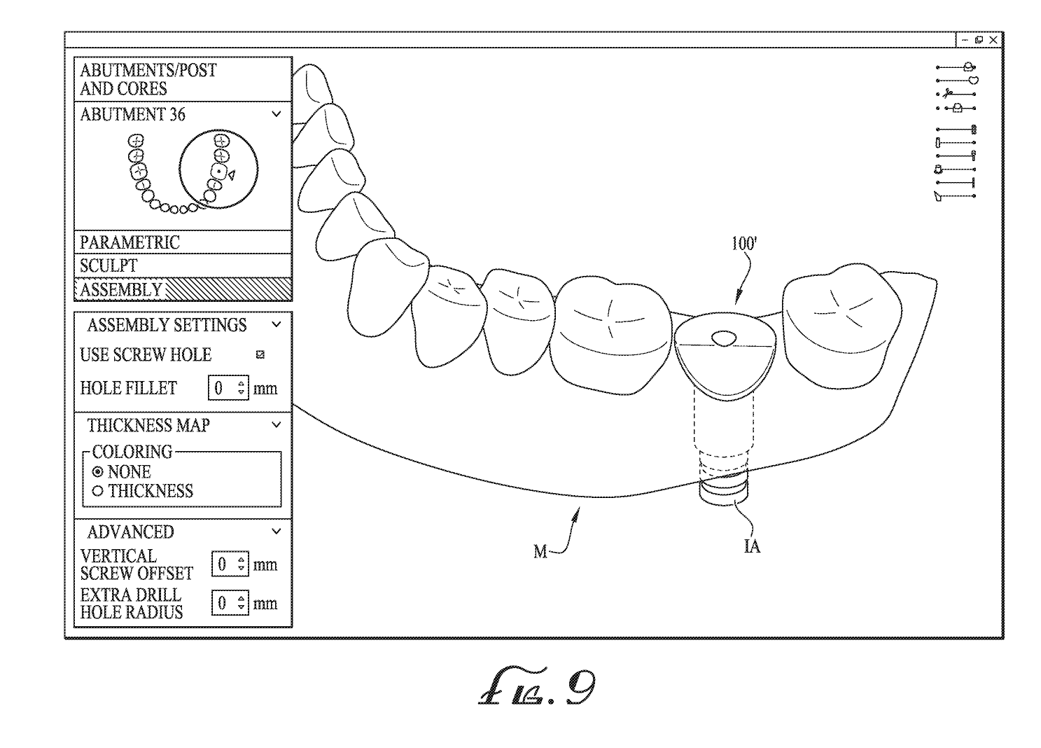

According to another example embodiment, a healer or healing abutment can be customized and similarly scanned for realizing the location, position and orientation of the implant that is installed within the patient's jaw bone. As depicted in FIG. 9, a digitally-designed custom healing abutment 100′ is aligned with the realized position of the implant or implant analog of the patient's scanned digital model M. According to example embodiments, prior to installation of the implant, a three-dimensional digital model M of the patient's detention, neighboring teeth relative to where the implant is intended to be installed and gingiva can be viewed and manipulated in the dental design software. According to some example embodiments, for example, in the case of guided surgery, the location, position and orientation of the implant to be installed in the patient's jaw bone is determined within the dental design software. In one example embodiment, the digitally-designed custom healing abutment 100′ can be initially positioned and oriented within the digital model at the location of the to-be-installed implant. The healing abutment 100′ can then be assessed against the digital model M, neighboring teeth and gingiva profile, and for example, the healing abutment 100′ can further be customized or revised based on how it appears to fit and support the gingiva surrounding the to-be-installed implant. Further, the healing abutment 100′ can comprise a custom subgingival emergence profile so as to benefit healing of the gingiva and train the same so as to comprise an aesthetically pleasing gingival profile when the final restoration is installed with the implant.

FIG. 10 depicts a physical custom healing abutment 100 that is substantially similar (if not identical) to the digitally-designed custom healing abutment 100′. According to example embodiments, the custom healing abutment 100 comprises an asymmetrical upper body portion 102 and a connection portion 140. The upper body portion 102 comprises a supragingival portion 104 and a subgingival portion 120. The supragingival portion 104 defines a first surface 110 and a second surface 112. In example embodiments, the first and second surfaces 110, 112 are preferably visible and exposed above the gingiva when the healing abutment 100 is placed and secured with the implant. In example embodiments, the first and second surfaces 110, 112 are typically planar and are generally not planar with respect to each other, for example, so as to define definite surfaces during the scanning or impression process such that the surfaces are defined within the three-dimensional digital model M, for example, such that the digitally-designed healing abutment 100′ can be aligned with the healing abutment 100 of the digital model and realize the implant's position. In alternate example embodiments, the first and second surfaces 110, 112 can non-planar or shaped otherwise.

The subgingival portion 120 preferably comprises a custom subgingival emergence profile 122 to assist in both the healing of the gingiva surrounding the one or more implants and the development of a custom emergence profile by the gingiva and defined by a custom subgingival emergence profile 122. In example embodiments, the custom subgingival emergence profile 122 not only supports and trains the gingiva surrounding the implant, the custom subgingival emergence profile benefits the healing process of the gingiva. Further, as the healing abutment 100 is also a scan body, the custom dental component need not be removed from the implant in order to obtain a physical or digital three-dimensional digital model, and thus, the surrounding gingiva remains supported by the custom subgingival emergence profile 122 up until the custom dental component is to be removed for replacement with a new, revised or different custom dental component (e.g., temporary restoration according to one example). In example embodiments, a lower portion of the upper body portion 102 comprises an implant contact portion 130 (or lower abutment surface) for butt-joint contact with the top face of the dental implant when placed in the patient's mouth (or correspondingly with the annular abutment contact surface of the implant analog).

The connection portion 140 is generally similar to the connection portion 20 as described above, for example, which is generally hexagonal in shape and configured for closely fitting installation within a hexagonal recess of the implant (or implant analog). In example embodiments, the connection portion 140 defines one or more planar surfaces 142, for example, about six surfaces to define the hexagonal shaped connection portion 140. A bore or conduit 160 can be formed through the entirety of the healing abutment 100 so as to allow a fastener or abutment screw to extend therethrough for securing the healing abutment 100 to the implant. According to one example embodiment, the connection portion 140 can be configured for frictionally engaging the hexagonal recess of the implant or implant analog, for example, such that a fastener or screw is not required to maintain secure engagement of the connection portion 140 with the implant or implant analog. According to one example embodiment, one or more snap-in releasable engagement features or engagement ribs 150 are provided on at least one of the surfaces 142.

In example embodiments, the engagement ribs 150 generally extend horizontally along at least one of the surfaces 142, and a groove or flat 152 generally extends along one or more sides of the engagement ribs 150. In example embodiments, the engagement ribs 150 are dimensioned to be at least slightly larger than a majority of the surface it is formed on for providing a frictional engagement fit with the hexagonal recess of the implant. For example, where the implant comprises a female hexagonal (“hex”) configuration and the connection portion 140 is a male hex configuration, the engagement ribs 150 extend or project outwardly at least partially beyond the dimension of the female hex of the implant, for example, so that there is at least a slight amount of interference between the first and second engagement sections to provide for a releasable or detachable friction fit therebetween. According to one example embodiment, the frictional engagement therebetween is substantially sufficient so as to prevent unintentional or accidental removal of the healing abutment 100 from the implant or implant analog. Optionally, the connection of the healing abutment 100 with the implant or implant analog can be secured by a combination of frictional engagement and the screw.

In example embodiments, the healing abutment 100 can be formed to comprise a monolithic construction, for example, wherein the asymmetrical upper body portion 102 and a connection portion 140 are formed from a single unitary piece of material. For example, according to example embodiments, the monolithic abutment is formed from a desired material and is milled or machined so as to form a one-piece healing abutment 100 comprising the asymmetrical upper body portion 102 integrally formed with the connection portion 140. According to example embodiments, the one-piece healing abutment 100 can be fabricated from a desirable material such as titanium, cobalt chrome (CoCr), other metals or metal alloys, ceramic, polyether ether ketone (PEEK) or poly(methyl methacrylate) (PMMA). In alternate example embodiments, other materials as desired can be provided to fabricate the one-piece healing abutment 100.

According to one alternate embodiment, the healing abutment 100 can comprise a two-piece assembly or hybrid healing abutment 200, for example, as depicted in FIG. 11. In example embodiments, the healing abutment 200 comprises an asymmetrical upper abutment portion 202 and a base implant-connecting portion 230. As shown, the asymmetrical upper abutment portion 202 can be generally similar to the upper body portion 102 of the monolithic healing abutment 100, for example, which is generally asymmetrical in shape and comprises a supragingival portion 204 and a subgingival portion 206. In example embodiments, the supragingival portion 204 defines a first surface 210 and a second surface 212. In example embodiments as similarly described above, the first and second surfaces 210, 212 are preferably visible and exposed above the gingiva when the healing abutment 100 is placed and secured with the implant.

As similarly described above, the subgingival portion 206 preferably comprises a custom subgingival emergence profile 214 to assist in both the healing of the gingiva surrounding the one or more implants and the development of a custom emergence profile by the gingiva and defined by a custom subgingival emergence profile 206. In example embodiments, the custom subgingival emergence profile 206 not only supports and trains the gingiva surrounding the implant, the custom subgingival emergence profile benefits the healing process of the gingiva. According to example embodiments, a bore extends through the entirety of the asymmetrical upper abutment portion 202, for example, to provide for fitting engagement with an upper connecting post 232 of the base implant-connecting portion 230. The base implant-connecting portion 230 comprises the upper connecting post 232, a base collar portion 236, and the connection portion 240. The base collar portion 236 is generally symmetrical and cylindrical and provides a platform for supporting the lower end of the asymmetrical upper abutment portion 202. As similarly described above, the base collar portion 236 comprises an implant contact portion 237 (or lower abutment surface) for butt-joint contact with the top face of the dental implant when placed in the patient's mouth (or correspondingly with the annular abutment contact surface of the implant analog).

According to example embodiments, the upper connecting post 232 comprises a protrusion 234 that is configured for fitting engagement with a recess 220 of the asymmetrical upper abutment portion 202, for example, to maintain a certain orientation of the asymmetrical upper abutment portion 202 with the upper connecting post 232. According to example embodiments, the protrusion 234 and recess 220 define a registration point so as to prevent full seating engagement of the asymmetrical upper abutment portion 202 with the base implant-connecting portion 230. Optionally, other complementary alignment features can be provided with the abutment and base portions 202, 230 such that rotation of one of the portions 202, 230 relative to the other of the portions 202, 230 is prevented. In example embodiments, the asymmetrical upper abutment portion 202 and base implant-connecting portion 230 are bonded together with adhesive, glue, cement or by other attachment means. For example, according to one example embodiment, the asymmetrical upper abutment portion 202 can be configured for frictional snap-in engagement with the base implant-connecting portion 230 rather than adhering the two together. According to one example embodiment, one or more surface and/or engagement features can be provided with the asymmetrical upper abutment portion 202 and base implant-connecting portion 230 so as to facilitate the frictional snap-in engagement therebetween.

The connection portion 240 is generally similar to the connection portion 140 as described above, for example, which is generally hexagonal in shape and configured for closely fitting installation within a hexagonal recess of the implant (or implant analog). In example embodiments, the connection portion 240 defines one or more planar surfaces 242, for example, about six surfaces to define the hexagonal shaped connection portion 240. According to one example embodiment, the connection portion 240 can be configured for frictionally engaging the hexagonal recess of the implant or implant analog, for example, such that a fastener or screw is not required to maintain secure engagement of the connection portion 240 with the implant or implant analog. According to one example embodiment, one or more snap-in releasable engagement features or engagement ribs 250 are provided on at least one of the surfaces 242.

As similarly described above, the engagement ribs 250 generally extend horizontally along at least one of the surfaces 242, and a groove or flat 252 generally extends along one or more sides of the engagement ribs 250. In example embodiments, the engagement ribs 250 are dimensioned to be at least slightly larger than a majority of the surface it is formed on for providing a frictional engagement fit with the hexagonal recess of the implant. For example, where the implant comprises a female hexagonal (“hex”) configuration and the connection portion 240 is a male hex configuration, the engagement ribs 250 extend or project outwardly at least partially beyond the dimension of the female hex of the implant, for example, so that there is at least a slight amount of interference between the first and second engagement sections to provide for a releasable or detachable friction fit therebetween. According to one example embodiment, the frictional engagement therebetween is substantially sufficient so as to prevent unintentional or accidental removal of the healing abutment 200 from the implant or implant analog. Optionally, the connection of the healing abutment 200 with the implant or implant analog can be secured by a combination of frictional engagement and the screw.

According to other alternate embodiments, the asymmetrical upper abutment portion 202 can be configured for mounting atop a stock or custom abutment, for example, rather than being configured for mounting atop the base implant-connecting portion 230. According to example embodiments, regardless of whether the healing abutment is formed to comprise a monolithic construction or a hybrid construction, the healing abutment is preferably recognizable during the scanning or impression process so as to be visible in the three-dimensional digital model M, for example, such that the location, position and orientation of the implant or implant analog IA can be realized.

According alternate example embodiments, a stock or custom full contour tooth or coping/cut-back framework can be connected with the base implant-connecting portion 230, for example, rather than the asymmetrical upper abutment portion 202.

According to another example embodiment of the present invention, the custom dental component can comprise a bridge or bridged framework, which can preferably act as a scan body (as described above) so as to realize the position of one or more implants. According to example embodiments, the bridge is typically supported by one or more implants and can comprise one or multiple teeth connected therewith, for example, depending on the patient's specific requirements. According to one example embodiment, the bridge or bridged framework is connected to a single tooth and is secured to the patient's jaw bone by a single implant. As such, the bridge or bridged framework can act as a scan body such that the bridge or bridged framework is visible in the three-dimensional digital model M and the single implant's location, position and orientation can be realized. According to another example embodiment, the bridge or bridged framework is connected to multiple teeth and is secured to the patient's jaw bone by a single implant. Similarly, the bridge or bridged framework can act as a scan body such that the bridge or bridged framework is visible in the three-dimensional digital model M and the single implant's location, position and orientation can be realized. According to another example embodiment, the bridge or bridged framework is connected to multiple teeth and is secured to the patient's jaw bone by a multiple implants. In example embodiments, the bridge or bridged framework can act as a scan body such that the bridge or bridged framework is visible in the three-dimensional digital model M and each of the multiple implants' location, position and orientation can be realized. Thus, according to example embodiments, a bridge or bridged framework that is connected to multiple implants preferably allows for the realization of each of the implants' locations, positions and orientations. According to one example embodiment, after one of the multiple implants' positions is realized, the location, position and orientation of the other of the multiple implants can be obtained. According to another example embodiment, the location, position and orientation of each of the multiple implants are realized simultaneously, for example, rather than realizing the location, position and orientation of one of the implants to determine the location, position and orientation of the other implants.

According to example embodiments, the bridge or bridged framework can preferably be secured to the one or more implants as desired. According to one example embodiment, a screw or fastener can be provided for securing the bridge or bridged framework to each of the one or more implants. According to another example embodiment, the bridge or bridged framework comprises one or more frictional snap-in releasable engagement features such that the bridge or bridged framework is retained in the one or more implants without a screw. According to another example embodiment, the bridge or bridged framework comprises one or more frictional snap-in releasable engagement features and the bridge or bridged framework is retained in the one or more implants with a screw. Thus, the bridge or bridged framework can be retained in the one or more implants by fastener, frictional snap-in engagement or a combination of fasteners and frictional snap-in engagement.

While the invention has been described with reference to example embodiments, it will be understood by those skilled in the art that a variety of modifications, additions and deletions are within the scope of the invention, as defined by the following claims.

What is claimed is:

1. A custom dental component for secure attachment with an implant or implant analog, the custom dental component comprising a custom subgingival emergence profile so as to support the gingiva surrounding the implant, the custom dental component being a digital impression coping such that it is recognizable by a scanner to produce at least a portion of a digital three-dimensional dental model showing the custom dental component and surrounding gingiva and detention, wherein the custom dental component need not be temporarily replaced with an impression coping or scan body to realize the position of the implant or implant analog.

2. The custom dental component of claim 1, wherein once the custom dental component is securely attached to the implant, the custom dental component remains securely attached with the implant until placement of a final restoration, wherein an impression coping or digital scan body need not be attached to the implant to determine the implant's position and surrounding gingiva and detention.

3. The custom dental component of claim 2, wherein the emergence profile of the custom dental component is configured to train the surrounding gingiva and produce a desirable gingival profile for compatibility with an emergence profile of the final restoration.

4. The custom dental component of claim 1, further comprising a design and planning software for accessing the digital three-dimensional dental model, wherein a digitally-designed custom dental component that is substantially similar to the custom dental component is aligned with the custom dental component that is visible in the digital three-dimensional dental model, the alignment of the digitally-designed custom dental component with the custom dental component of the digital three-dimensional dental model being configured for producing the implant's position and orientation within a patient's jaw bone.

5. The custom dental component of claim 4, wherein one or more digitally-designed stock or custom dental components can be aligned with the digitally-designed custom dental component so as to be properly positioned relative to the implant or implant analog.

6. The custom dental component of claim 1, wherein the custom dental component comprises a custom healing abutment.

7. The custom dental component of claim 1, wherein the custom dental component comprises a stock or custom abutment.

8. The custom dental component of claim 1, wherein the custom dental component comprises a stock or custom coping.

9. The custom dental component of claim 1, wherein the custom dental component comprises a stock or custom full contour tooth

10. The custom dental component of claim 1, wherein the custom dental component comprises a stock or custom bridge and/or bridged framework.

11. The custom dental component of claim 1, wherein the custom dental component is monolithic and formed from a single unitary material.

12. The custom dental component of claim 1, wherein the custom dental component comprises a hybrid construction having at least two components that are connected together by frictional engagement or an adhesive.

13. The custom dental component of claim 12, wherein the two components of the custom dental component are configured for frictionally snapping together.

14. The custom dental component of claim 1, wherein the custom dental component comprises a connection that is configured for engagement with a connection receiver of the implant or implant analog.

15. The custom dental component of claim 14, wherein the connection is configured frictionally engaging the connection receiver so as to retain the custom dental component with the implant or implant analog without a screw, the frictional engagement being sufficient so as to prevent unintentional removal of the connection from the connection receiver.

16. The custom dental component of claim 14, wherein the connection is configured frictionally engaging the connection receiver so as to retain the custom dental component with the implant or implant analog, and wherein a screw is provided to further secure the custom dental component to the implant or implant analog.

17. A method of realizing the position of an implant of a patient comprising:
obtaining a scan of at least a portion of a patient's jaw bone, wherein at least one implant is installed in at least a portion of the patient's jaw bone;
digitally designing a custom dental component for attachment to an implant that is to be installed in the patient's jaw bone;
manufacturing the digitally-designed custom dental component to produce a physical custom dental component;
installing the physical custom dental component in the implant of the patient;
obtaining a scan of the patient, the scan providing visibility of the physical custom dental component;
aligning the digitally-designed custom dental component with the physical custom dental component that is visible in the scan of the patient; and
realizing the position of the implant of the patient.

18. The method of Clam 17, wherein one or more additional digital dental components can be aligned relative to the digitally-designed custom dental component that is aligned with the physical custom dental component and visible in the scan of the patient, the one or more additional digital dental components being positioned and oriented based on the position of the implant or implant analog, the one or more additional digital dental components being customizable so as to train the surrounding tissue to provide a desired emergence profile.

19. The method of claim 17, wherein the custom dental component comprises a custom healing abutment.

20. The method of claim 17, wherein the custom dental component comprises a custom temporary abutment and a temporary restoration is attached with the custom temporary abutment.

21. The method of claim 17, wherein the custom dental component comprises a custom final abutment and a final restoration is attached with the custom final abutment.

22. The method of claim 17, wherein the custom dental component comprises a crown or full contour tooth.

23. The method of claim 17, wherein the custom dental component comprises a bridge or bridged framework.

24. The method of claim 23, wherein at least two implants are installed within the patient's jaw bone, and wherein aligning the digitally-designed custom dental component with the custom dental component of the digital three-dimensional dental model identifies the position of the at least two implants.

25. The method of claim 17, wherein the custom dental component is monolithic and formed from a single unitary material.

26. The method of claim 17, wherein the custom dental component comprises a hybrid construction having at least two components that are connected together.

27. A method of realizing the position of an implant of a patient comprising:
digitally designing a custom dental component for attachment to the implant, the digitally-designed custom dental component being sized and shaped according to nondigital measurements;
manufacturing the digitally-designed custom dental component to produce a physical custom dental component;
installing the physical custom dental component in the implant of the patient;
obtaining a scan of the patient to produce at least a portion of a digital three-dimensional dental model showing the custom dental component and surrounding gingiva and detention;
aligning the digitally-designed custom dental component with the custom dental component of the digital three-dimensional dental model; and
realizing the position of the implant of the patient, wherein one or more stock or custom digitally-designed dental components can be aligned relative to the digitally-designed custom dental component that is aligned with the custom dental component of the digital three-dimensional dental model.

28. The method of claim 27, wherein the one or more stock or custom digitally-designed dental components are selected from the group consisting of an implant, an implant analog, a stock or custom healing abutment, a stock or custom temporary abutment or final abutment, a stock or custom temporary restoration or final restoration, and a stock or custom bridge or bridged framework.
